(19) United States
(12) Patent Application Publication
(10) Pub. No.: US 2026/0029336 A1
(43) Pub. Date: Jan. 29, 2026

(54) Sight Glass Liquid and Vapor Recognition Device Using Light Reflection

(71) Applicant: Westermeyer Industries Inc., Bluffs, IL (US)

(72) Inventors: David Robert Frenk, Chatham, IL (US); Adam T. Chapman, Winchester, IL (US)

(21) Appl. No.: 19/279,034

(22) Filed: Jul. 24, 2025

Related U.S. Application Data
(60) Provisional application No. 63/675,899, filed on Jul. 26, 2024.

(51) Int. Cl. G01N 21/3504; G01N 21/3577

(52) U.S. Cl. CPC G01N 21/3504; G01N 21/3577

(57) ABSTRACT

A liquid and vapor recognition device is described herein comprising a housing configured to connect to a sight port including a sight glass and including an interior reflective surface, a first circuit component comprising a plurality of light emitting diodes (LEDs) and a light sensor, the first circuit component being mounted within the housing proximate the sight glass with the interior reflective surface of the housing disposed opposite the LEDs, and a second circuit component mounted proximate the first circuit component, the second circuit component containing a plurality of analog to digital converters (ADCs). Reflections of the LEDs from the interior reflective surface are detected by the light sensor, and the light sensor communicates with the plurality of ADCs, which output a digital signal indicative of the intensity of the reflected light.

### BACKGROUND

Cycles and/or systems may utilize a working fluid that experiences phase change to operate effectively. To function appropriately and efficiently this fluid must be either a fluid or a vapor, and in some instances not a mixture of both. This is appropriate for refrigeration systems where part of the cycle depends on the refrigerant being a liquid prior to the expansion process, whereas only a vapor is required prior to the compression process. The refrigerant is contained within a piping network that connects mechanical components responsible for the phase changes. Often small peripherals with a circular viewing port of the operating fluid are added to the piping network to monitor the phase of the process fluid or refrigerant. The fluid state within this viewing port or sight glass is monitored manually.

It would be useful to develop an improved device and system for monitoring the liquid and vapor phases of the refrigerant in a refrigeration system.

### SUMMARY OF THE INVENTION

One embodiment described herein is a liquid and vapor recognition device comprising a housing configured to connect to a sight port including a sight glass and including an interior reflective surface, a first circuit component comprising a plurality of light emitting diodes (LEDs) and a light sensor, the first circuit component being mounted within the housing proximate the sight glass with the interior reflective surface of the housing disposed opposite the LEDs, and a second circuit component mounted proximate the first circuit component. The second circuit component includes a plurality of analog to digital converters (ADCs). Reflections of the LEDs from the interior reflective surface are detected by the light sensor, and the light sensor communicates with the plurality of ADCs, which output a digital signal indicative of the intensity of the reflected light.

In embodiments, the housing is configured to be attached to a fluid-containing line, and the intensity of the reflected light indicates the relative quantity of liquid and vapor phases of the fluid in the line. In embodiments, when the sight port is filled with a fluid in a vapor state, the reflection of the LEDs from the reflective surface is greater than when the sight port is filled with a fluid in the liquid state.

In disclosed embodiments, the device includes a micro-controller with a micro-controller circuit configured to analyze the digital signal. In embodiments, the micro-controller circuit contains a memory configured to save luminance intensity values for both pure vapor and pure liquid states within the memory. In some cases, the device is calibrated automatically using instructions from the micro-controller. In embodiments, through an averaging process using software associated with the micro-controller, the device is configured to illuminate an external LED to a color designating the relative quantities of liquid and vapor phases of the fluid within the sight port.

Another embodiment described herein is system comprising a working fluid configured to change phase between a liquid and a vapor during circulation through the system, and the above-described sight glass liquid and vapor recognition device disposed proximate a location in the system at which the desired phase of the working fluid is substantially all vapor or substantially all liquid. In some cases, the system is a refrigeration system and the working fluid is a refrigerant. In embodiments, the system includes at least one of an expansion valve and a compressor, and the sight glass liquid and vapor recognition device is positioned upstream from at least one of an inlet to the expansion valve and an inlet to the compressor. In some cases, the system communicates with a control system configured to operate the refrigeration system.

Yet another embodiment is sight glass liquid and vapor recognition device comprising a plurality of light emitting diodes (LEDs) mounted directly onto a sight glass which is fixed within a housing having a reflective surface opposite the LED source, and a circuit component mounted adjacent to the LEDs. The circuit component contains a photodiode array comprising a plurality of photodiodes and analog to digital converters (ADCs) capable of detecting a plurality of colors and a lack of color (clear). Reflections of the LEDs within the housing are detected by the photodiodes, and the photodiodes direct the current for each color to the ADCs to output a digital signal that is configured to be analyzed by a software-containing micro-controller circuit.

### BRIEF DESCRIPTION OF THE DRAWINGS

FIG. 1 is a perspective view of a first embodiment of a sight glass liquid and vapor recognition device described herein.

FIG. 2 is a line drawing of a vertical sectional view of the first embodiment.

FIG. 3 is a shaded version of the vertical sectional view of the first embodiment.

FIG. 4 is a top view of the first embodiment.

FIG. 5 is a front elevational view of the first embodiment.

FIG. 6 is a side elevational view of the first embodiment.

FIG. 7 is a sectional view of the first embodiment taken along line 7-7 of FIG. 5.

FIG. 8 is a graph showing LED light intensity vs. time for Example 1.

FIG. 9 is an exploded perspective view, as seen from above, of a second embodiment of the device described herein.

FIG. 10 is an exploded perspective view, as seen from below, of the second embodiment.

FIG. 11 is a perspective view of the second embodiment.

FIG. 12 schematically shows an example of a system that incorporates the device of FIGS. 1-7.

### DETAILED DESCRIPTION

The disclosed embodiments improve the efficiency of refrigeration systems by providing an operator with an indication of the degree to which liquid refrigerant is present in a line that is intended to contain substantially all vapor refrigerant, and the degree to which vapor refrigerant is present in a line that is intended to contain substantially all liquid refrigerant. The device incorporates LED lights using colors to represent the vapor and liquid states of refrigerant streams. The device also can include IR LEDs to detect when a vapor-liquid mix changes. The device can be mounted at a location in a system line at which a sight glass port is useful.

One embodiment of the device described herein uses a combination of a visible light emitting diode (LED) and an infrared light emitting diode (IR-LED) mounted to a circuit board. The circuit board is contained within the housing and optionally can be mounted directly onto the sight glass, wherein the sight glass of a sight port is fixed within the housing. The housing is configured with a reflective surface opposite the LED and IR-LED source. In some cases, the LED and IR-LED are mounted by soldering. Other suitable mounting techniques also can be used. In some cases, the reflective surface is formed by machining an inner surface of a housing that is made of a metal, such as brass, although other metals can be used. The machining process creates a smooth reflective surface.

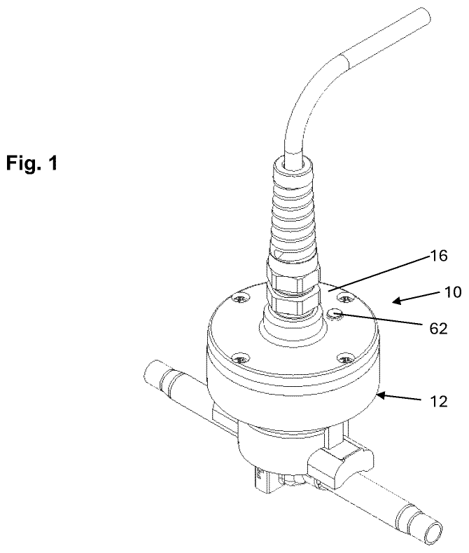

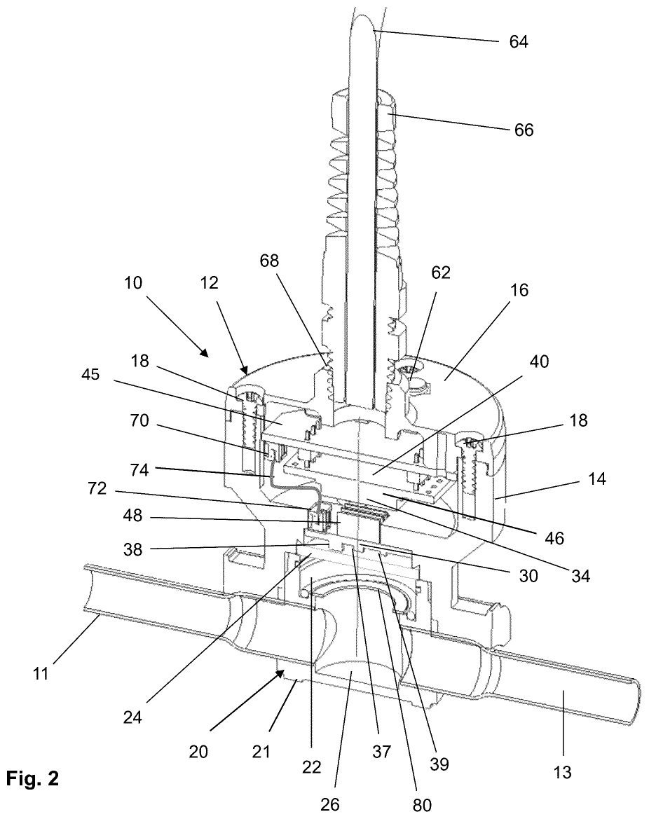

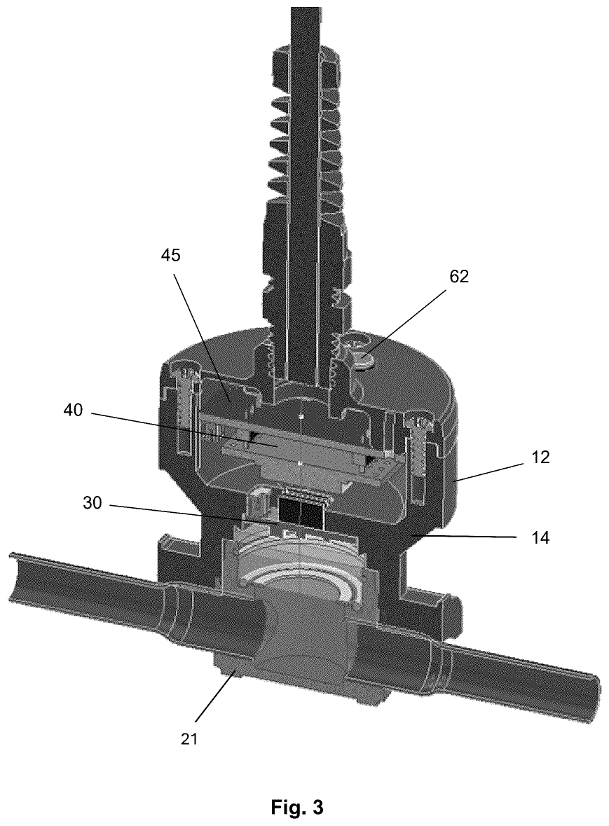

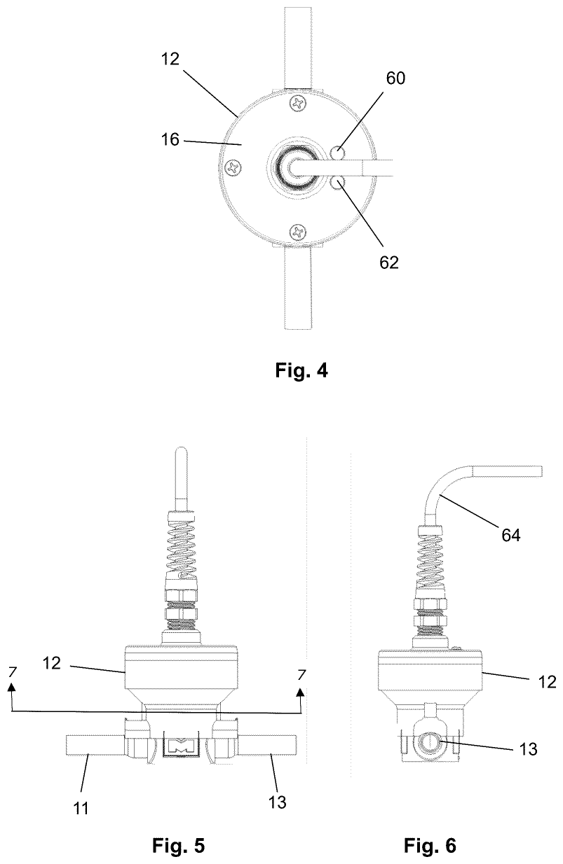

FIGS. 1-7 show a non-limiting example of the first embodiment of the liquid and vapor recognition device. The sight glass liquid and vapor recognition device, which is generally designated as 10, comprises a device housing 12 mounted between fluid lines 11, 13. The device housing 12 includes an enclosure 14 and a cover 16. The cover 16 is attached to the enclosure 14 with a plurality of fasteners 18.

A sight port housing 21 and a sight port 22 are assembled to form a sight glass assembly 20, which is connected to the both the enclosure 14 and the fluid lines 11, 13. In embodiments, the sight port housing 21 comprises a metal such as brass, and a reflective surface 26 is formed by machining an inner surface of sight glass housing 21 opposite to light sensors 37a, 37b, which are described below. In embodiments, the sight port 22 comprises glass. A transparent disc 24 is positioned adjacent to the sight port 22 and is configured to prevent water, moisture, and dirt from accumulating on the surface of a circuit board 30. The transparent disc 24 optionally may be made of plastic.

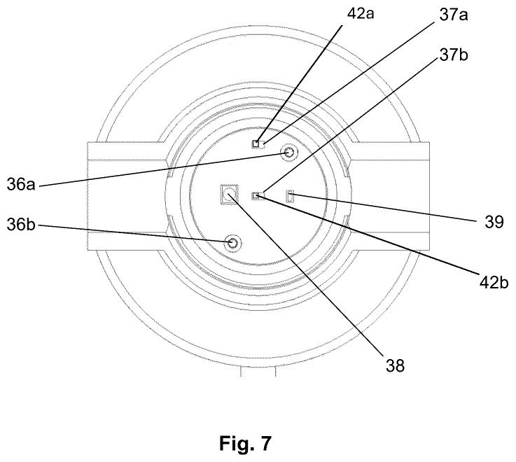

The device housing 12 contains three circuit boards. The micro-controller circuit board 40 is configured to support analog to digital converters (ADCs) 46 to output a digital signal indicative of light intensity, and a micro-controller 34. Due to space constraints, a circuit board 45 is positioned adjacent to the circuit board 40 that has external LEDs 60, 62 and other supporting components/circuitry for the micro-controller circuit board 40. The device housing 12 further contains a circuit board 30 mounted between the circuit board 40 and the sight glass assembly 20 using mounting screws 36a and 36b. The circuit board 30 supports at least one visible LED 38, at least one infrared LED (IR-LED) 39, and at least one light sensor 37b. In FIG. 7, two light sensors 37a, 37b are shown. Light sensors 37a, 37b are RGB-IR sensors. Reflections of the LED and IR-LED from the reflective surface 26 within the housing are detected by the light sensors 37a, 37b. The light sensors 37a, 37b often comprise photodiode arrays 42a, 42b, respectively, each including a plurality of photodiodes capable of detecting red, green, blue colors, and no color (clear). Sensors 37a and 37b are also configured to detect non-visible infrared light. The light sensors 37a, 37b sense light intensity and convert the sensed light intensity and color to electrical signals, which are transmitted to the ADCs 46.

In embodiments, the digital signal from the ADCs 46 is analyzed by a micro-controller circuit in the micro-controller 34. The micro-controller 34 is configured to use software to generate an output to an operator regarding the status of liquid and vapor in the lines 11, 13. The software can be contained within the microcontroller circuit 34. The circuit board 30 includes a heat sink 48 configured to dissipate heat generated by the circuit board components, primarily the LED component.

The light sensors 37a, 37b are capable of detecting luminous intensity, defined by the metric unit of lux. When the sight port 21 is filled with a fluid in a vapor state, the reflection of the LEDs 38 from the reflective surface 26 is greater than when the sight port 21 is filled with a fluid in the liquid state. The difference in luminance lux can be detected by the light sensors 37a, 37b. The light sensors 37b can detect the intensity of reflected light of red, blue, and green colors. In embodiments, the light sensor 37b also can detect infrared light from the IR-LED 39 reflected from the reflective surface 26. The light sensor 37a detects the red/green/blue change of an outer moisture strip 80, described below. The light sensor 37a is positioned so the light reflections of the outer moisture are more direct.

The device 10 uses two reference states to compare the readings to determine the refrigerant state of vapor and/or liquid at any given time. Following initial installation of the device to the sight glass port 21, the device 10 tracks the light reflections over a given predetermined time interval to determine if installation has taken place. Within this light reflection polling time interval, there will be less instantaneous light change when the device is installed to the sight glass port 21 as compared to the light sensors 37a, 37b detecting ambient light when the device 10 is not installed to the sight glass port 21. Based on this less instantaneous light change, the circuit micro-controller 34 will execute software instructions that will determine light reflection extremes, including minimums and maximums. As the refrigeration system, or other system, operates, these extremes will adjust, increasing or decreasing based on the fluid flow through the sight glass assembly 20. The rate of change of these minimum and maximum light reflections will soon approach near zero, at which point these values can be used as state (liquid vs. vapor) reference points. When the fluid is all liquid, reflectance is high. When the fluid is all vapor, reflectance is low.

The phase of the fluid can be in three states including all vapor, all liquid, or a combination of both. Through an averaging process in the software associated with the micro-controller 34, the device 10 illuminates external LEDs 60, 62 to a color designating the state of the fluid within the sight port. Further to the external LEDs 60, 62, an analog signal can be transmitted by a cable 64 to a larger control system 70 responsible for the operation of the entire cycle or system in which the sight port is installed.

The photodiode arrays 42a, 42b can detect red, green, and blue (RGB). An output to the microcontroller software can differentiate the RGB combination to determine the color of an optional paper indicator 80 concentric with the view port. If a color detected presents an issue that should be corrected, the device 10 can generate an output signal to a larger control system that can initiate a warning to the system operator. In embodiments the output signal is sent by a cable. The paper indicator 80 changes color in reaction to moisture present within the fluid, where this fluid is refrigerant. The paper indicator is one color with moisture present, another color with no moisture present. In some refrigeration systems, moisture can be harmful to the system as the presence can induce acid formation that may be harmful to components.

The refrigeration or air conditioning system on which the sight glass port 21 is installed, may operate any time without predetermined intervals. The device is not required to be connected to the main system controller to be turned on at time of operation. The device is able to constantly monitor the refrigerant state. During off cycles the refrigerant as viewed through the sight glass housing could be liquid or vapor state but will not be changing and will remain in a static state until the system restarts. During system operation it is also possible the state of the refrigerant could remain constant. The LED 38 responsible for providing the visible light will not provide the same light intensity throughout the life of the device. The degradation of the LED 38 intensity can be attributed to the heat generated within the LED component.

During intervals in which there is no change to the refrigerant state, it is feasible to disable the LED 38 and utilize the infrared radiation LED (IR LED) 39 to monitor the refrigerant state. In the disclosed embodiment, the IR LED 39 is positioned next to the visible light LED 38 on the circuit board 30. The light sensors 37a, 37b can detect IR as well as RBG. The IR LED 39 will not degrade in intensity due to lack of heat generation compared to the visible light LED. If the light sensors 37a, 37b detect changes in the IR, the visible light LED 38 can be enabled to detect light reflections to determine the refrigerant state.

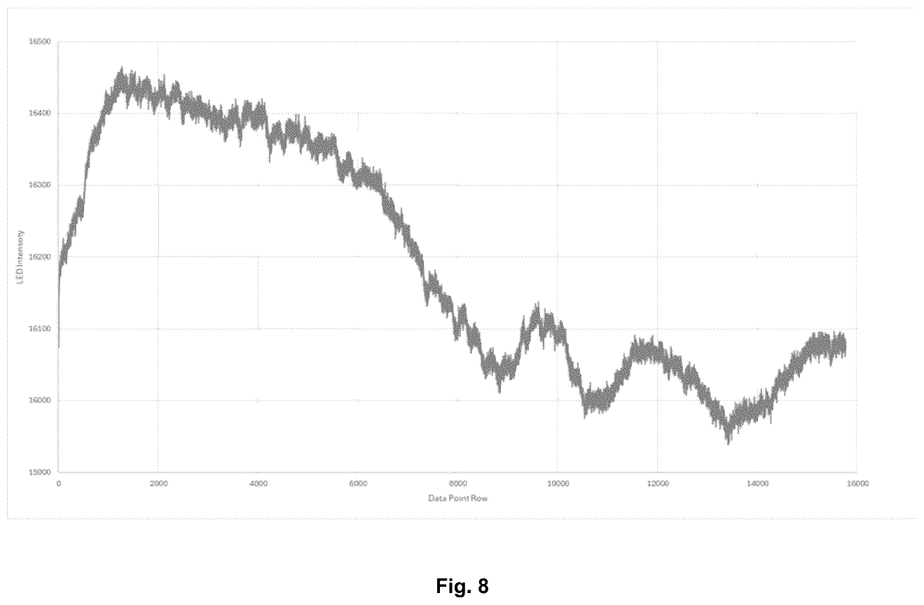

FIG. 8 is a graph showing LED intensity in units of Lux versus time for Example 1. The graph shows that the use of the IR sensor helps extend the life of the LED. The test duration was about 4300 hours.

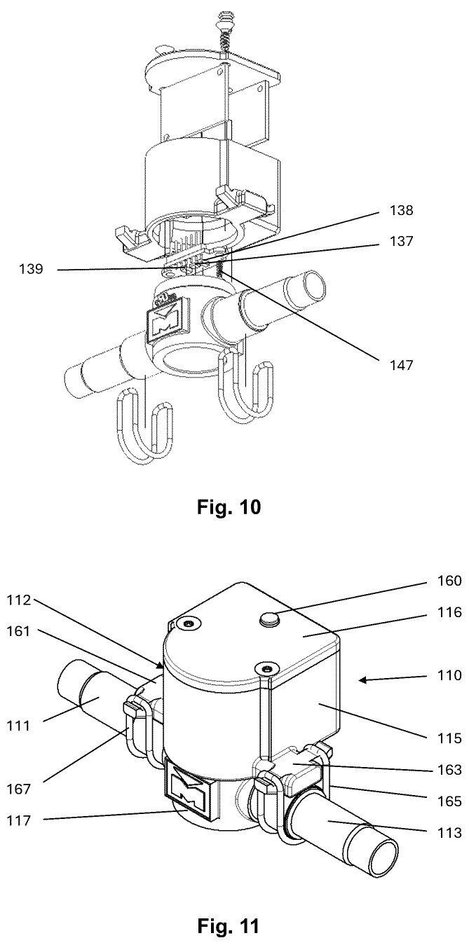

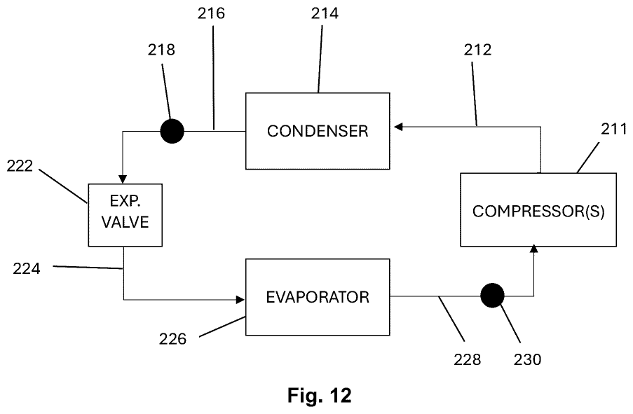

Another embodiment described herein in a method of determining the liquid and vapor states in a stream of a working fluid. The method comprises using the devices shown in FIGS. 1-7 and 9-12 to measure luminous intensity of the stream, which correlates to a ratio of vapor to liquid for the working fluid. The method is particularly useful to monitor the state of the refrigerant stream in a refrigeration system.

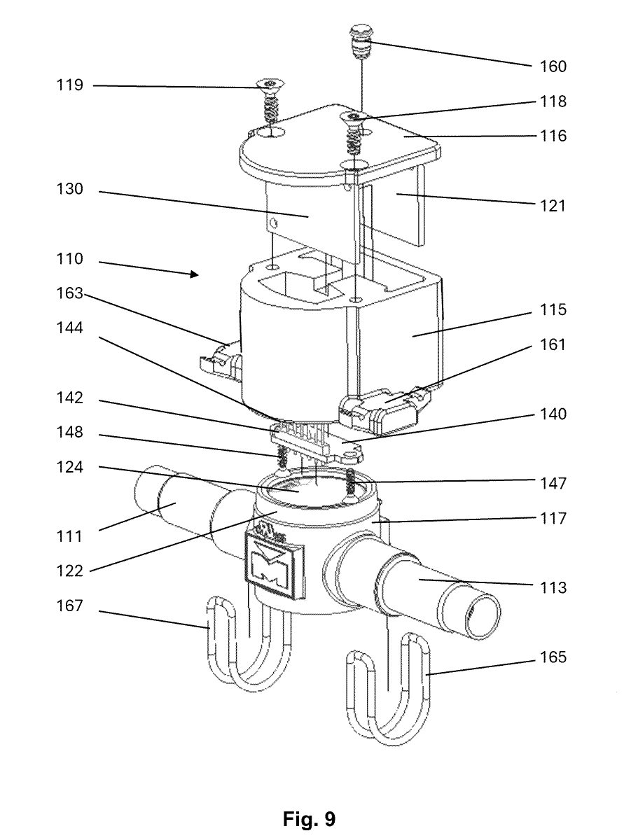

A further embodiment of the vapor and liquid recognition device described herein is illustrated in FIGS. 9-11. The device 110 uses light emitting diodes (LEDs) 132 mounted directly onto the sight glass 124 of a sight port 122, where the sight glass 124 is fixed within a machined housing 112. The machining process creates a reflective surface 119 opposite the LEDs 132. A circuit component 140 containing a photodiode array 142 containing photodiodes 144 and analog to digital converters (ADCs) 146, capable of detecting red, green, blue, and clear colors, is mounted adjacent to the LEDs 132. Reflections of the LEDs 132 within the machined housing 112 are detected by the photodiodes 144. The photodiodes 144 direct the current for each color to the ADCs 146 to output a digital signal that may be analyzed by a software containing micro-controller circuit 134.

The photodiode array 142 is also capable of detecting luminous intensity, defined by the metric unit of lux. When the sight port 122 is filled with a fluid in a vapor state, the reflection of the LEDs 138 on the machined surface 119 is greater than when the sight port 122 is filled with a fluid in the liquid state. The difference in luminance lux can be detected by the photodiode array 142. The circuit 135 of the connected microcontroller 134 can save this luminance lux value for both the vapor and liquid states within it's memory storage. Upon initial installation of the device 110, the operator can press a button, connected to the microcontroller 134, for various time intervals to initiate a saving process. This saving or calibration process is required when the sight port 122 contains only vapor and only liquid. These saved values serve as reference points for when the fluid changes from vapor to liquid and back to vapor.

As with the first embodiment, in this second embodiment, the phase of the fluid can be in three states including all vapor, all liquid, or a combination of both. Through an averaging process in the software of the microcontroller 134, the device 110 can illuminate an external LED 160 to a color designating the state of the fluid within the sight port. Further to the external LED 160, an analog signal can be transmitted by a cable 164 to a larger control system 170 responsible for the operation of the entire cycle or the system in which the sight port is installed.

The photodiode array 142 can detect red, green, and blue (RGB). An output to the microcontroller software can differentiate the RGB combination to determine the color of a paper indicator 180 concentric with the sight port 122. If a color detected presents an issue indicating that the ratio of vapor to liquid refrigerant is not the desired ratio, an output from the device 110 can be transmitted by a cable 164 to the larger control system 171 to initiate a warning to the system operator.

An embodiment of a refrigeration system in which the device can be used is shown in FIG. 12 and is generally designated as 210. The system 210 includes a compressor 211 fluidly connected by piping 212 to a condenser 214. The condenser 214 is connected to an expansion valve 222 by line 216, designated as a liquid line. The liquid and vapor recognition device 218 may be mounted inline with the piping of line 216. The purpose of the installation location for the device 218 is to verify only liquid refrigerant is shown in the sight glass. Low pressure/low temperature refrigerant liquid is carried from the expansion valve 222 to the evaporator 226 by piping 224. The evaporator 226 is responsible for cooling the intended media (air or liquid), causing the liquidized gas to evaporate. The device 218 also may be mounted between the evaporator 226 and the compressor 21, inline with the piping 228 designated as the suction line to the compressor 211. In some embodiments, the sight glass housing was pre-installed. The purpose of this second installation location is to verify only vapor is shown in the sight glass. The evaporated refrigerant gas is then carried to the compressor 211 by piping 228 to repeat the cycle. In embodiments, the refrigerant is R404A, R454B, R448A, R449A, R744, or R290.

A number of alternatives, modifications, variations, or improvements therein may be subsequently made by those skilled in the art, which are also intended to be encompassed by the following claims.

What is claimed is:

1. A liquid and vapor recognition device, comprising:
a housing configured to connect to a sight port including a sight glass, and comprising an interior reflective surface,
a first circuit component comprising a plurality of light emitting diodes (LEDs) and a light sensor, the first circuit component being mounted within the housing proximate the sight glass, with the interior reflective surface of the housing disposed opposite the LEDs, and
a second circuit component mounted proximate the first circuit component, the second circuit component including a plurality of analog to digital converters (ADCs),
wherein reflections of the LEDs from the interior reflective surface are detected by the light sensor, and the light sensor communicates with the plurality of ADCs, which output a digital signal indicative of the intensity of the reflected light.

2. The device of claim 1, wherein the LEDs include at least one visible LED and at least one infrared LED (IR-LED).

3. The device of claim 1, further comprising a micro-controller circuit configured to analyze the digital signal.

4. The device of claim 1, wherein the housing is configured to be attached to a fluid-containing line, and the intensity of the reflected light indicates the relative quantity of liquid and vapor phases of the fluid in the line.

5. The device of claim 1, wherein the light sensor is configured to detect luminous intensity.

6. The device of claim 1, wherein the light sensor is configured to detect luminous intensity as visible light.

7. The device of claim 1, wherein the light sensor is configured to detect luminous intensity as visible light and infrared light.

8. The device of claim 1, wherein the light sensor includes an RGB sensor.

9. The device of claim 1, wherein the light sensor includes an infrared light sensor.

10. The device of claim 1, wherein the light sensor comprises a photodiode array containing a plurality of photodiodes.

11. The device of claim 10, wherein a difference in luminous intensity over time can be detected by the photodiode array.

12. The device of claim 1, wherein, when the sight port is filled with a fluid in a vapor state, the reflection of the LEDs from the reflective surface is greater than when the sight port is filled with a fluid in the liquid state.

13. The device of claim 3, wherein the micro-controller circuit contains a memory configured to save luminance intensity values for both pure vapor and pure liquid states within the memory.

14. The device of claim 3, wherein the device is calibrated automatically using instructions from the micro-controller.

15. The device of claim 14, wherein, through an averaging process using software associated with the micro-controller, the device is configured to illuminate an external LED to a color designating the relative quantities of liquid and vapor phases of the fluid within the sight port.

16. A system comprising:
a working fluid configured to change phase between a liquid and a vapor during circulation through the system, and
the sight glass liquid and vapor recognition device of claim 1, disposed proximate a location in the system at which the desired phase of the working fluid is substantially all vapor or substantially all liquid.

17. The system of claim 16, wherein the system is a refrigeration system and the working fluid is a refrigerant.

18. The system of claim 17, wherein the system includes at least one of an expansion valve and a compressor, and the sight glass liquid and vapor recognition device is positioned proximate at least one of an inlet to the expansion valve and an inlet to the compressor.

19. The system of claim 17, further comprising a control system configured to operate the refrigeration system.

20. A sight glass liquid and vapor recognition device, comprising:
a plurality of light emitting diodes (LEDs) mounted directly onto a sight glass which
is fixed within a housing having a reflective surface opposite the LED source, and
a circuit component mounted adjacent to the LEDs, the circuit component containing a photodiode array comprising a plurality of photodiodes and analog to digital converters (ADCs) capable of detecting a plurality of colors and a lack of color (clear),
wherein reflections of the LEDs within the housing are detected by the photodiodes, and
wherein the photodiodes direct the current for each color to the ADCs to output a digital signal that is configured to be analyzed by a software-containing micro-controller circuit.
